(19) United States
(12) Patent Application Publication
(10) Pub. No.: US 2026/0127811 A1
(43) Pub. Date: May 7, 2026

(54) THREE-DIMENSIONAL (3D) POINT CLOUD PERCEPTION

(71) Applicant: QUALCOMM Incorporated, San Diego, CA (US)

(72) Inventors: Shizhong Steve HAN, San Diego, CA (US); Hong CAI, San Diego, CA (US); Hsin-Pai CHENG, San Diego, CA (US); Soyeb Noormohammed NAGORI, San Diego, CA (US); Jihad MASRI, Mississauga (CA); Fatih Murat PORIKLI, San Diego, CA (US)

(21) Appl. No.: 18/939,216

(22) Filed: Nov. 6, 2024

(51) Int. Cl. G06T 15/20; G06T 9/00

(52) U.S. Cl. CPC G06T 15/20; G06T 9/002; G06T 2210/56

(57) ABSTRACT

Systems and techniques are described herein for processing three-dimensional (3D) data. For example, a computing device can process a plurality of voxels to generate a plurality of tokens associated with the 3D data; process, using a linear layer of an encoder, an embedding dimension of the plurality of tokens to modify the plurality of tokens; adjust, using a layer of the encoder, an order of the modified plurality of tokens to generate a rearranged plurality of tokens; and process the modified plurality of tokens and the rearranged plurality of tokens to determine relationships between input features of the plurality of tokens.

### TECHNICAL FIELD

The present disclosure generally relates to processing three-dimensional (3D) data. For example, aspects of the present disclosure relate to systems and methods for 3D point cloud perception.

### BACKGROUND

Three-dimensional (3D) perception based on point cloud data has critical applications in the fields of autonomous driving, robotics, and augmented reality. The decreasing cost of light detection and ranging (LIDAR) devices has made real-time autonomous driving increasingly feasible, utilizing both camera and LIDAR sensors. LIDAR sensors can provide accurate 3D location information in varying illumination and weather conditions. LIDAR sensors can allow for data to be captured including ranging information, allowing devices to have a depth measurement (e.g., range measurement) associated with detected objects. The depth measurements can be represented as volumetric pixels (e.g., voxels).

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In some aspects, an apparatus for processing three-dimensional (3D) data. The apparatus can include at least one memory and at least one processor coupled to the at least one memory and configured to: process a plurality of voxels to generate a plurality of tokens associated with the 3D data; process, using a linear layer of an encoder, an embedding dimension of the plurality of tokens to modify the plurality of tokens; adjust, using a layer of the encoder, an order of the modified plurality of tokens to generate a rearranged plurality of tokens; and process the modified plurality of tokens and the rearranged plurality of tokens to determine relationships between input features of the plurality of tokens.

In some aspects, a method for processing three-dimensional (3D) data is provided. The method can include: processing a plurality of voxels to generate a plurality of tokens associated with the 3D data; processing, using a linear layer of an encoder, an embedding dimension of the plurality of tokens to modify the plurality of tokens; adjusting, using a layer of the encoder, an order of the modified plurality of tokens to generate a rearranged plurality of tokens; and processing the modified plurality of tokens and the rearranged plurality of tokens to determine relationships between input features of the plurality of tokens.

In some aspects, a non-transitory computer-readable medium is provided having stored thereon instructions that, when executed by at least one processor, cause the at least one processor to: process a plurality of voxels to generate a plurality of tokens associated with the 3D data; process, using a linear layer of an encoder, an embedding dimension of the plurality of tokens to modify the plurality of tokens; adjust, using a layer of the encoder, an order of the modified plurality of tokens to generate a rearranged plurality of tokens; and process the modified plurality of tokens and the rearranged plurality of tokens to determine relationships between input features of the plurality of tokens.

In some aspects, an apparatus for processing three-dimensional (3D) data is provided. The apparatus includes: means for processing a plurality of voxels to generate a plurality of tokens associated with the 3D data; means for processing, using a linear layer of an encoder, an embedding dimension of the plurality of tokens to modify the plurality of tokens; means for adjusting, using a layer of the encoder, an order of the modified plurality of tokens to generate a rearranged plurality of tokens; and means for processing the modified plurality of tokens and the rearranged plurality of tokens to determine relationships between input features of the plurality of tokens.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The preceding, together with other features and aspects, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 is a diagram illustrating an example of a block (e.g., a voxel block), in accordance with some examples.

FIG. 2 is a block diagram illustrating an example of another voxel block with values, in accordance with some examples.

FIG. 3 is a block diagram illustrating an example architecture for three-dimensional (3D) voxelization, in accordance with some examples.

FIG. 4 is a block diagram illustrating an example architecture for a three-dimensional (3D) sparse backbone engine, in accordance with some examples.

FIG. 5 is a block diagram illustrating an example architecture for a two-dimensional (2D) aerial view engine, in accordance with some examples.

FIG. 6 is a flow diagram illustrating an example of a process for image processing, in accordance with some examples.

FIG. 7 is a block diagram illustrating an example of a neural network that can be used for image processing, in accordance with some examples.

FIG. 8 is a block diagram illustrating an example of a system for implementing certain aspects described herein.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein can be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Three-dimensional (3D) perception based on point cloud data can include resource intensive operations. As more portable electronic devices, such as smartphones, laptops, tablets, virtual reality (VR)/extended reality (XR) headsets, etc. perform functions using 3D perception, improvements in the efficiency of operations for performing 3D perception can allow a greater range of devices to perform 3D perception. For example, machine learning models can be used to learn sparse features of 3D backbones from 3D point clouds.

Traditional 3D dense convolutions can be memory and computationally expensive due to redundant computations in empty or unoccupied regions. 3D sparse convolutions can be used to reduce memory usage and computation. However, many 3D sparse convolutions are not hardware-friendly (e.g., not easily performed by hardware due to hardware architecture). For example, many 3D sparse convolutions are not hardware-friendly because the convolutions can use irregular memory access patterns and data structures difficult for many devices to access, store, and manipulate. been introduced.

Other approaches, such as using dynamic sparse voxel transformers (DSVT), can use transformers to replace 3D sparse convolutions. While transformers can include feature learning capabilities, transformers can be computationally expensive which can cause transformers to be less suitable for deployment compared to traditional convolutions. Further, latent information and opinion networks (LION) models can use recurrent neural networks (RNN), such as linear recurrent neural networks, to reduce computational resources. In such an example, the RNNs generally still use 3D sparse convolutions requiring complex hardware architecture.

Systems, apparatuses, processes (also referred to as methods), and computer-readable media (collectively referred to as “systems and techniques”) are described herein for 3D point cloud perception. For example, the systems and techniques described herein for improved efficiency in performing 3D object detection using 3D point clouds (e.g., performance of 3D object detection using fewer computational resources), which can provide real-time (or near real-time) 3D object detection.

In some aspects, the systems and techniques can include a 3D object pipeline including a 3D point cloud voxelization engine, a 3D sparse backbone engine, a 2D aerial view (e.g., birds-eye view (BEV)) engine, and a 3D detection engine (e.g., 3D detection head). In some aspects, improvements to the 3D object pipeline includes improvements to the 2D aerial view engine and the 3D sparse backbone engine.

In some aspects, the 3D point cloud voxelization engine can receive sensor data from one or more sensors (e.g., light detection and ranging (LIDAR) data from one or more LIDAR sensors, images from one or more cameras, etc.). The 3D point cloud voxelization engine can generate voxels based on the sensor data. Voxels (also referred to as volume blocks or volumetric pixels) are 3D representations of a scene. In some examples, voxels can be used to reconstruct a 3D scene from the sensor data (e.g., the LIDAR data, 2D images such as stereo images obtained from a stereo camera, etc.). Values of voxels can represent values associated with a regular grid in 3D space (e.g., value can represent light intensity, color, etc.). The voxels can be partitioned into various 2D grid representations to provide values of voxels at various distances (e.g., various depths of the voxel).

In some aspects, the 3D point cloud voxelization engine can use various techniques to generate voxels from a 3D point cloud. For example, the 3D point cloud voxelization engine can generate a structured grid of 3D cells, referred to as voxels or 3D voxels, from a 3D point cloud. The 3D point cloud voxelization engine can perform 3D submanifold sparse convolution. In further examples, the 3D point cloud voxelization engine can perform various serialized techniques (e.g., sequential processing of 3D point clouds or voxels). For example, the 3D point cloud voxelization engine can serialize 3D voxel features into a one-dimensional (1D) sequence. The sequence can be processed using a transformer or linear RNN model for 3D feature extraction.

In some aspects, the 3D point cloud voxelization engine can use the transformer or linear RNN models to sort the 3D voxels into x and y-order. The 3D point cloud voxelization engine can use the sorted 3D voxels (sorted into x and y-order) as inputs to the transformer or linear RNN models to perform 3D feature extraction. In some aspects, the 3D point cloud voxelization engine can use a voxel feature encoder (VFE) to convert into 3D voxels. In some examples, the 3D voxels are sparse voxels. A sparse voxel is a voxel including data (e.g., voxel values). For example, a plurality of sparse voxels can represent portions of a 3D space including objects and can have empty 3D space (e.g., space in an environment without a detected object) removed from the plurality.

In some aspects, the 3D sparse backbone engine can be a machine learning model (e.g., a neural network) to perform feature extraction of voxels. For example, the 3D sparse backbone engine can receive voxels generated by the 3D point cloud voxelization engine. The 3D sparse backbone engine can perform feature extraction techniques to process the voxels and extract features associated with the voxels. In some aspects, the 3D sparse backbone engine can generate a plurality of tokens representing features associated with a voxel. In some examples, the 3D sparse backbone engine can include one or more linear layers. For example, the 3D sparse backbone engine can receive ordered 3D sparse data from the 3D point cloud voxelization engine at a first linear layer. In some examples, the 3D sparse backbone engine can perform a transpose operation to the output of the first linear layer. For example, the output of the linear layer can be a plurality of tokens associated with the voxel, plurality of voxels, or the ordered 3D sparse data. The 3D sparse backbone engine can perform a transpose operation on the output of the first linear layer. In some examples, the 3D sparse backbone engine includes a first transpose layer to perform the transpose operation.

In some aspects, the 3D sparse backbone engine can provide the output of the first transpose layer or transpose operation to a layer (e.g., a convolution layer). For example, the layer is a convolution layer that is part of a convolutional neural network (CNN). In one illustrative example, the convolution layer can be a one-dimensional (e.g., Conv1d) convolution layer. The output of the layer (e.g., the convolution layer) can be provided to a second transpose layer, or the 3D sparse backbone engine can perform a transpose operation on the output of the layer. The 3D sparse backbone engine can perform an element-wise multiplication of the output of a second linear layer (e.g., a second linear layer which received the ordered 3D sparse data) and the output of the second transpose layer. The output of the element-wise multiplication can be provided to a third linear layer of the 3D sparse backbone and summed with the ordered 3D sparse data or a plurality of tokens representing the ordered 3D sparse data. The output of the summation can be provided to a series of linear layers (e.g., two or more additional linear layers) and summed again with the ordered 3D sparse data or a plurality of tokens representing the ordered 3D sparse data.

The 3D sparse backbone engine can include a series of ConvDotMix1D modules or blocks. For example, the ConvDotMix1D modules are sets of layers of the previously described linear layers, convolution layers, and transpose layers. The 3D sparse backbone engine can use the linear layers for channel mixing of voxels and the convolution layer for token mixing (e.g., to adjust the order of tokens from the plurality of tokens. In some aspects, the 3D sparse backbone engine can use the element-wise product of the output of the second linear layer with the output of the second transpose layer to increase non-linearity between the features of the voxel as represented in the plurality of tokens. By increasing the non-linearity, the 3D sparse backbone engine can determine relationships between features of the voxel, which can be used for object detection.

In some aspects, the 3D sparse backbone engine can generate a one-dimensional (1D) vector of data based on the ordered 3D sparse data. For example, 3D sparse features (e.g., features of the voxel or 3D point cloud) can be serialized into a 1D sequence of data (e.g., sequence of tokens, plurality of tokens). In some examples, serializing the 1D sequence of data can include partitioning the voxels (e.g., partitions also referred to as windows of voxels) and sorting the partitions. Partitioning can ensure that local features within a window are near each other after serializing the partition (e.g., near each other in the sequence of tokens, plurality of tokens). Sorting the partitions or the plurality of tokens can organize the 3D sparse features into a 1D structured sequence of data with ordered neighborhood relationships (e.g., ordered based on proximity).

In some examples, a voxel can be partitioned into non-overlapping 3D partitions (e.g., windows) represented by (Wx, Wy, Wz). Each partition can be represented by (Wx, Wy, Wz) coordinates or dimensions, with Wx representing length, Wy representing width, and Wz representing height. In some examples, the 3D sparse backbone engine can serialize the 3D voxels into a 1D sequence by sorting the voxels along the X-axis as primary order (e.g., first order or Raster order), followed by Y-axis and Z-axis as the second and third order respectively. In some examples, sorting can be done with the Y-axis as the primary order. In some examples, the 3D sparse backbone engine can divide the 1D sequence into fixed-length groups for faster computation. For different partitions of voxels, increased group sizes can be used to facilitate information sharing among groups and increase the length of feature interactions (e.g., relationships). For example, the block with 128-size group can be followed by a block with a doubled 256-size group, allowing features from two neighborhood 128-size groups to be merged into the 256-size group.

In some aspects, the 2D aerial view (e.g., BEV) engine can receive the output of the 3D sparse backbone engine. For example, the 2D aerial view engine can output a plurality of tokens associated with a voxel or plurality of voxels. For example, the output of the 2D aerial view engine can be a feature map including values associated with an input voxel. The values can be represented as a plurality of tokens. In some examples, the plurality of tokens can be represented as a matrix. In further examples, the plurality of tokens can be represented as a vector.

The 2D aerial view engine can generate an aerial view based on the output of the 3D sparse backbone engine. In some aspects, kernels of the first convolution layer can perform element-wise multiplications and summations of values of the voxels to generate a feature map associated with the voxel. In some examples, the 3D sparse backbone can receive 3D sparse data from the 3D point cloud voxelization engine. In some examples, the 3D sparse data can be a plurality of tokens associated with one or more voxels.

For example, the 2D aerial view engine can include a first convolution layer to perform a convolution on tokens associated with a voxel or plurality of voxels to mix (e.g., rearrange or adjust the order of) the plurality of tokens. In some examples, the 2D aerial view engine can include a plurality of convolution layers (e.g., two-dimensional convolutional layers such as Conv2d-1 to Conv2d-K) in series (referred to as the first series of convolution layers) with an output of the first convolution layer providing an input to a subsequent convolution layer to rearrange the order of tokens from the plurality of tokens. The 2D aerial view engine can perform element-wise multiplication (e.g., Hadamard multiplication) of values associated with the plurality of tokens rearranged from the series of convolution layers and another plurality of tokens rearranged using another convolution layer. The output of the element-wise multiplication can be provided as input to another convolution layer (e.g., another Conv2d) which can be summed with values associated with the input to the series of convolution layers. The output of the summation can be provided to an additional series of convolution layers to perform additional convolutions. In some aspects, the output of the additional series can be summed with the input to the first series of convolution layers. In some aspects, the 2D aerial view engine can be further extended to add further series of convolution layers and perform further summations of outputs with the input values.

In some aspects, the output of the 2D aerial view engine can be an aerial view grid representation of the voxels or 3D point cloud received by the 3D point cloud voxelization engine. For example, the aerial view grid can be a BEV grid providing a 2-dimensional grid representing an aerial view of the voxels or 3D point cloud. In some examples, a 3D detection engine (e.g., a 3D detection head) can use the aerial view grid or the output of the 3D sparse backbone to perform object detection. In further examples, the outputs of the 2D aerial view engine or the 3D sparse backbone can be used in other engines or heads. For example, the aerial view grid generated using the 2D aerial view engine can be used by applications for autonomous driving, parking assist, lane correction, etc.

Additional aspects of the present disclosure are described in more detail below.

As previously mentioned, recently, there has been a demand for 3D content for computer graphics, virtual reality, and communications, that has triggered a change in emphasis for the requirements. Many existing systems for constructing 3D models are built around specialized hardware that results in a high cost, which often cannot satisfy the requirements of these new applications. This need has stimulated the use of digital imaging facilities (e.g., cameras) for 3D reconstruction.

Currently, volume blocks (e.g., voxel blocks) are often used to reconstruct a 3D scene from 2D images (e.g., stereo images obtained from a stereo camera). A voxel block will be used herein as an example of blocks (e.g., 3D blocks or volume blocks). A voxel block can represent a value on a regular grid in 3D space. As with pixels in a 2D bitmap, voxel blocks themselves do not have their position (e.g., coordinates) explicitly encoded within their values. Instead, rendering systems infer the position of a voxel block based upon its position relative to other voxel blocks (e.g., its position in the data structure that makes up a single volumetric image).

3DR utilizes depth frames with an associated live camera pose estimate for scene reconstruction. In 3D surface reconstruction, the scene can be modeled as a 3D sparse volumetric representation (e.g., that can be referred to as a volume grid). The volume grid contains a set of voxel blocks that are indexed by their position in space with a sparse data representation (e.g., only storing blocks that surround an object and/or obstacle). For example, a room with a size of four meters (m) by four m by five m may be modeled with a volume grid having a total of 1.25 million (M) voxel blocks, where each voxel block has a four-centimeter block dimension. In some examples, for this room, the occupied voxel blocks may only be about ten to fifteen percent.

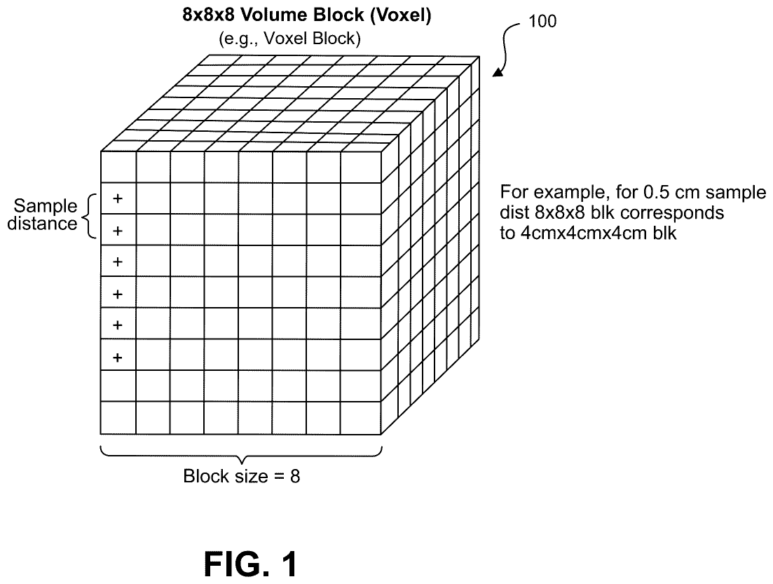

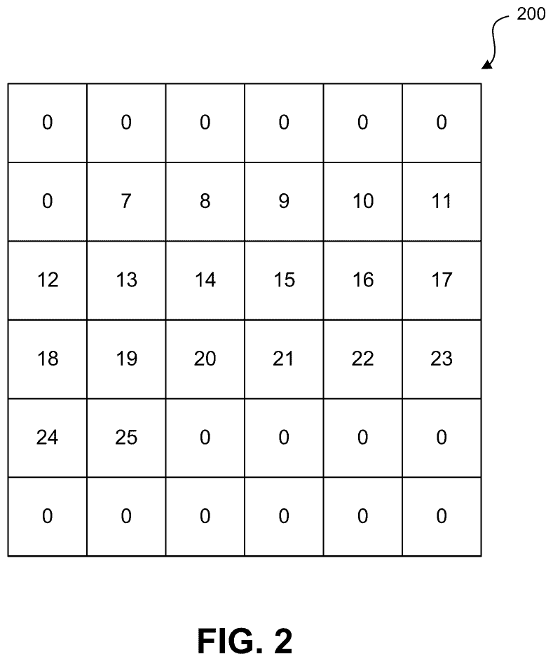

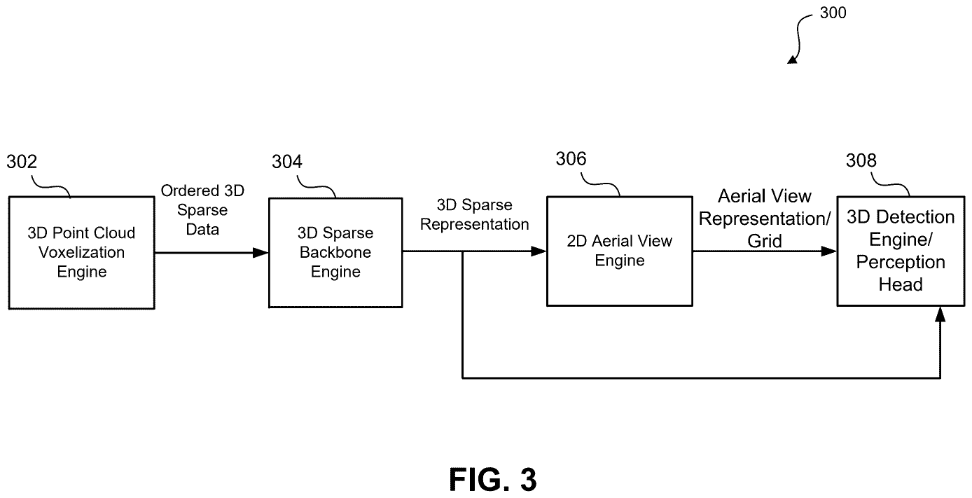

The above-mentioned image capture and processing systems and devices for 3D scene reconstruction and can be used to perform the various image processing described in FIGS. 3-9. FIG. 1 and FIG. 2 illustrate example voxels which can be used by the image capture and processing systems and devices for 3D scene reconstruction to perform object detection, 2D aerial view grid construction, etc.

FIG. 1 is a diagram illustrating an example of a volume block (e.g., a voxel block) 100. In FIG. 1, the voxel block 100 is shown to have a block size of eight (e.g., eight voxels within a voxel block). For example, a 0.5-centimeter (cm) sample distance for an eight by eight by eight voxel block can correspond to a four cm by four cm by four cm voxel block. That is, the voxel block 100 includes a 3D lattice of 212 voxels, the voxels arranged so that the voxel block 100 has a width of 8 voxels, a length of 8 voxels, and a height of 8 voxels.

In some examples, the voxel block 100 is not a dimensioned equally across every row or column. For example, a sparse voxel block can be a voxel block with individual voxels removed throughout the voxel block. For example, when voxel block 100 is a sparse voxel block, voxels of the sparse voxel block without respective values (e.g., voxels representing empty space) can be removed from the voxel block. By removing voxels from voxel block 100 without values (e.g., voxels for empty space) image capture and processing systems can process the voxel block using fewer computing resources because fewer voxels are processed.

FIG. 2 is an example of a partition 200 of a voxel block. For example, various voxels of the partition 200 include an associated value. For example, the value can represent color values (e.g., red-green-blue (RGB) values). In some examples, the value can represent light intensity. In further examples, the values can represent distance from a camera capturing images of a scene represented by the voxel block (and partition 200).

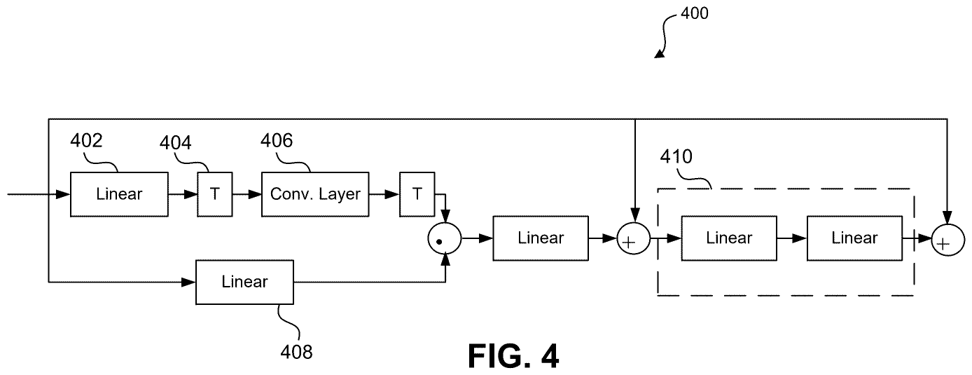

By way of a non-limiting example, the partition 200 can a partition of voxel block 100 of FIG. 1. A 3D sparse backbone engine, such as the 3D sparse backbone engine further described in the description of FIG. 3 and FIG. 4 can partition the voxel block 100 into a partition 200 based on distance (e.g., partition voxel blocks into predetermined dimensions). The 3D sparse backbone engine can sort the 3D sparse data of the partition (e.g., the values of the partition) based on x-y coordinates of the values within the partition 200. In some examples, the 3D sparse backbone engine can obtain an ordered sequence as a pre-processing step. In some examples, a 3D point cloud voxelization engine, further described in the description of FIG. 3, can be used to order the 3D sparse data or partition voxel blocks.

As illustrated in FIG. 2, the voxel features are represented as a vector: [7,8,9,10,11,12,13,14,15,16,17] with corresponding indices of: [1, 1] [1,2] [1,3][1,4][1,5][2,0] [2,2] [2,3] [2,4] [2,5]. Below are two examples of reordering of the values of the partition 200 based on y-coordinates and based on x-coordinates.
Y order: [7,8,12,13,14,9,10,11,15,16,17,18,19,20,24,25,21,22,23]
X order: [12,7,13,8,14,9,15,10,16,11,17,18,24,19,25,20,21,22,23]

By reordering the values of partitions, the values associated with voxel features are closer to nearby voxels allowing convolutions to process neighboring or nearby voxel features together.

FIG. 3 is a block diagram illustrating example architecture 300 for three-dimensional (3D) voxelization. The example architecture 300 includes a 3D point cloud voxelization engine 302, a 3D sparse backbone engine 304, a two-dimensional (2D) aerial view engine 306, and a 3D detection engine/perception head 308.

The 3D point cloud voxelization engine 302 can receive a 3D point cloud to generate voxels. In some examples, the 3D point cloud voxelization engine 302 can receive sensor data, and generate voxels based on the sensor data. For example, the 3D point cloud voxelization engine can receive the sensor data from one or more LIDAR sensors and/or from an image sensor (e.g., one or more images from a camera) and generate voxels based on the sensor data. Voxels, as further described in the descriptions of FIG. 1 and FIG. 2, are 3D representations of a scene. In some examples, voxels can be used to reconstruct a 3D scene from the sensor data. Values of voxels can represent values associated with a regular grid in 3D space (e.g., voxel values can represent light intensity, color, depth, etc.). In some examples, the 3D point cloud voxelization engine 302 can partition voxels into various 2D grid representations to provide values of voxels at various distances from the sensor capturing the sensor data.

The 3D point cloud voxelization engine 302 can use various techniques to generate voxels from a 3D point cloud. For example, the 3D point cloud voxelization engine can generate a structured grid of 3D cells from a 3D point cloud by performing 3D submanifold sparse convolution on the 3D point cloud. In further examples, the 3D point cloud voxelization engine 302 can perform various serialized techniques (e.g., sequential processing of 3D point clouds or voxels) to generate voxels. For example, the 3D point cloud voxelization engine 302 can serialize features of the 3D point cloud into a one-dimensional (1D) sequence of voxel values.

In some examples, the 3D point cloud voxelization engine 302 is a machine learning model or can use a machine learning model such as a transformer or linear RNN models to sort 3D voxels generated using the 3D point cloud into x and y-order representations of the 3D voxels. The 3D point cloud voxelization engine 302 can use the sorted 3D voxels (e.g., the one-dimensional sequence of voxel values) as inputs to machine learning model to perform 3D feature extraction. For example, the 3D point cloud voxelization engine 302 can use a voxel feature encoder (VFE) to convert the 3D point cloud into 3D voxels.

In some examples, the 3D point cloud voxelization engine 302 can remove voxels from a voxel block without corresponding voxel values (e.g., voxels associated with empty space). For example, a plurality of voxels can represent portions of a 3D space including objects and an empty space. The 3D point cloud voxelization engine 302 can remove voxels from the plurality of voxels associated with the empty 3D space.

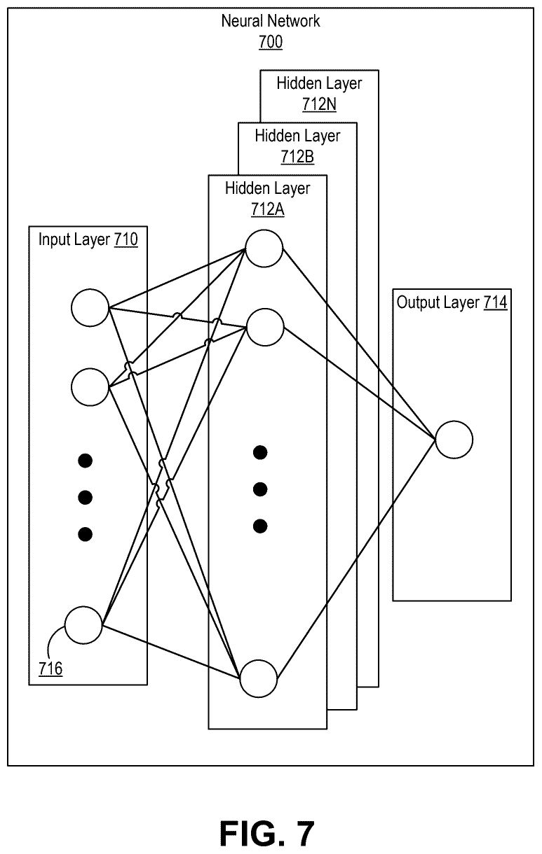

The 3D sparse backbone engine 304 can receive ordered 3D sparse data (e.g., a plurality of tokens associated with voxels generated by the 3D point cloud voxelization engine 302). In some examples, the ordered 3D sparse data is a 1D vector of voxel values. In some examples, the 3D sparse backbone engine 304 is or includes a machine learning model to perform feature extraction of voxels. For example, the 3D sparse backbone engine 304 can include a neural network such as the neural network of FIG. 7.

In some examples 3D sparse backbone engine 304 can receive voxels generated by the 3D point cloud voxelization engine 302 or the ordered 3D sparse data representing the voxels. The 3D sparse backbone engine 304 can perform feature extraction techniques to process the voxels to extract features (e.g., values and relationships between voxels) associated with the voxels. In some examples, the 3D sparse backbone engine 304 can generate a plurality of tokens representing features associated with a voxel. In further examples, the 3D sparse backbone engine 304 can include a plurality of linear layers, convolution layers, and transpose layers. In further examples, architecture of the 3D sparse backbone engine 304 can be adjusted to add more linear layers or remove linear layers. Further description of the 3D sparse backbone engine 304 is provided in the description of FIG. 4.

The 2D aerial view engine 306 (e.g., birds eye view (BEV)) can receive the output of the 3D sparse backbone engine 304 to generate an aerial view representation of a 3D scene represented by the voxels. In some examples, the 2D aerial view engine 306 is a machine learning model or includes a machine learning model. In further examples, the 2D aerial view engine 306 outputs an aerial view grid representation of the 3D scenes of the voxels from the 3D point cloud voxelization engine 302.

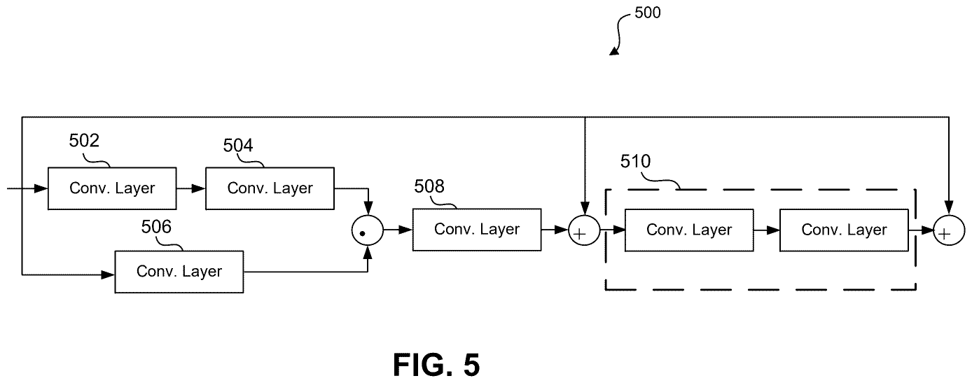

In some examples, the 2D aerial view engine 306 can output an aerial view representation (e.g., a BEV grid, aerial view grid, etc.) of the voxels generated by the 3D point cloud voxelization engine 302. For example, the output of the 2D aerial view engine 306 can be a 2-dimensional (x-y) grid representing an aerial view of the voxels or 3D point cloud. Further description of 2D aerial view engine 306 is provided in the description of FIG. 5.

The 3D detection engine/perception head 308 can use the outputs of the 2D aerial view engine 306 or the 3D sparse backbone engine 304 to perform various object detection and perception tasks. For example, the 3D detection engine/perception head 308 can provide a 3D sparse representation to an application to identify objects within an environment. In further examples, the 3D detection engine/perception head 308 can use an output aerial view grid (e.g., BEV grid) to perform various autonomous driving tasks such as parking assist, adaptive cruise control, lane control assist, etc.

FIG. 4 is a block diagram illustrating example architecture of a 3D sparse backbone engine 400 (e.g., the 3D sparse backbone engine 304 of FIG. 3). The 3D sparse backbone engine 400 is a machine learning model including various linear layers, transpose layers, and a convolution layer to perform feature extraction of voxels. For example, the 3D sparse backbone engine 400 can receive voxels generated by the 3D point cloud voxelization engine described further in the description of FIG. 3.

In some aspects, the 3D sparse backbone engine 400 can process a voxel to generate a plurality of tokens representing features associated with the voxel. The 3D sparse backbone engine 400 includes a first linear layer 402, a first transpose layer 404, and a convolution layer 406 in parallel with a second linear layer 408. The 3D sparse backbone engine 400 can receive ordered 3D sparse data at the first linear layer 402. In some examples, the first linear layer 402 can process a plurality of tokens associated with the voxel to modify embedding dimensions of the plurality of tokens. For example, the first linear layer 402 can modify embedding dimensions of the plurality of tokens to generate a modified plurality of tokens with different embedding dimensions.

The 3D sparse backbone engine 400 can provide the output of the first linear layer 402 to the first transpose layer 404. The first transpose layer 404 can transpose the modified plurality of tokens to adjust the dimensions (e.g., switching from a matrix of m×n dimensions to a matrix of n x m dimensions). The 3D sparse backbone engine 400 can provide the output of the first transpose layer 404 to the convolution layer 406. In some examples, the convolution layer 406 is a one-dimensional (1D) convolution layer (e.g., Conv1d). In some examples, the convolution layer 406 is a plurality of layers (e.g., Conv1d-1 to Conv1d-K). The 3D sparse backbone engine 400 can use the convolution layer 406 to rearrange the order of tokens from the modified plurality of tokens to determine relationships between tokens of the plurality (e.g., relationships between voxels and voxel values associated with the tokens).

The output of the convolution layer 406 can be provided to a second transpose layer. The 3D sparse backbone engine can perform an element-wise multiplication of the output of the second linear layer 408 in parallel with the first linear layer 402, the first transpose layer 404, and the convolution layer 406. The output of the element-wise multiplication can be provided to a third linear layer of the 3D sparse backbone engine 400 and summed with a plurality of tokens representing the ordered 3D sparse data. The output of the summation can be provided to a series of linear layers 410 (e.g., two or more additional linear layers) and summed again with the plurality of tokens representing the ordered 3D sparse data. In some examples, the 3D sparse backbone engine 400 can be extended by adding additional linear layers to the series of linear layers 410 or by adding additional linear layers after the second summation.

FIG. 5 is a block diagram illustrating example architecture of a 2D aerial view engine 500. The 2D aerial view engine 500 can receive the output of the 3D sparse backbone engine (e.g., the 3D sparse backbone engine 400 of FIG. 4). The output of the 2D aerial view engine can be a 2D grid representation (e.g., aerial view grid, BEV grid, etc.) of a scene represented by the voxels generated by a 3D point cloud voxelization engine (e.g., the 3D point cloud voxelization engine 302 of FIG. 3).

The 2D aerial view engine 500 can include a first convolution layer 502 to perform a convolution on a plurality of tokens associated with one or more voxels to mix (e.g., rearrange or adjust the order of) the plurality of tokens. In some examples, the 2D aerial view engine 500 can include a second convolution layer 504 in series with the first convolution layer 502 to further rearrange the order of the plurality of tokens. The 2D aerial view engine 500 can further include a third convolution layer 506 in parallel with the first convolution layer 502 and the second convolution layer 504. In some examples, the 2D aerial view engine 500 includes more than two convolution layers in parallel with the third convolution layer 506 (e.g., K number of convolution layers represented by Conv2d-1 to Conv2d-K).

In some examples, the first convolution layer 502 and the second convolution layer 504 can be part of a series of convolution layers. In further examples, the first convolution layer 502 and the second convolution layer 504 are two-dimensional convolutions. The 3D aerial view engine 500 can perform an element-wise multiplication of the out of the second convolution layer 504 and the third convolution layer 506. The results of the multiplication can be provided to a fourth convolution layer 508 and summed with the plurality of tokens receive by the first convolution layer 502 and the third convolution layer 506. The output of the summed plurality of tokens can be provided to an additional series of convolution layers 510 to perform additional convolutions. The output of the additional series of convolution layers 510 can be summed with the input to the first convolution layer 502 and the third convolution layer 506. In some examples, the 2D aerial view engine 500 can include additional series of convolution layers added after the additional series of convolution layers 510.

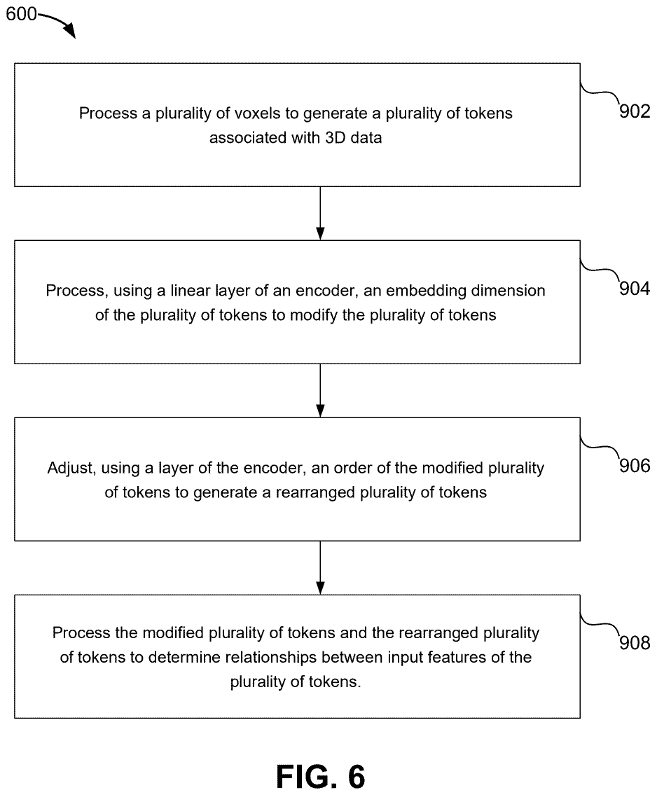

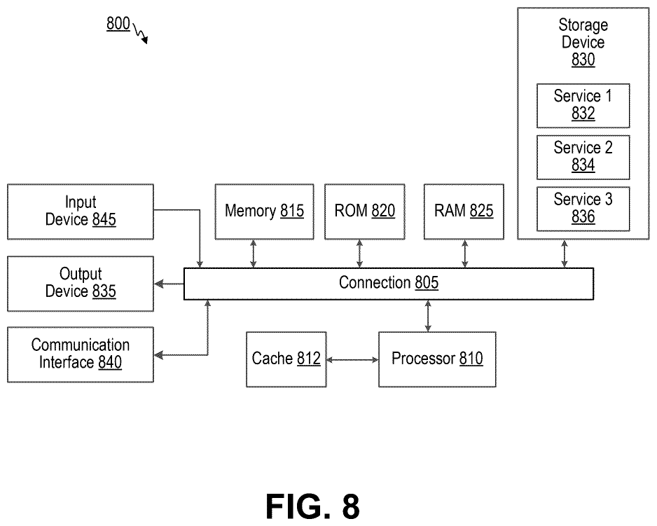

FIG. 6 is a flow diagram illustrating an example of a process 600 for processing three-dimensional (3D) data. The process 600 can be performed by a computing device (e.g., computing device or computing system 800 of FIG. 8, etc.) or by a component or system, a chipset, one or more processors central processing units (CPUs), digital signal processors (DSPs), graphics processing units (GPUs), any other type of processor(s), any combination thereof, or other component or system) of the computing device. The operations of the process 600 can be implemented as software components that are executed and run on one or more processors (e.g., processor 810 of FIG. 8 or other processor(s)) of the computing device. Further, the transmission and reception of signals by the computing device in the process 600 can be enabled, for example, by one or more antennas and/or one or more transceivers (e.g., wireless transceiver(s)).

At block 602, the computing device (or component thereof) can process a plurality of voxels to generate a plurality of tokens associated with 3D data. The process can include processing a plurality of voxels to generate a plurality of tokens associated with the 3D data. For example, the 3D data can be a 3D point cloud of data captured using a LIDAR sensor. The 3D point cloud can be received by an encoder of the computing device to generate the plurality of voxels.

At block 604, the computing device (or component thereof) can process, using a linear layer of an encoder, an embedding dimension of the plurality of tokens to modify the plurality of tokens. For example, the plurality of tokens can be associated with an input embedding vector of a first dimension (e.g., first dimension of size 300). The computing device (or component thereof) can process the plurality of tokens using the linear layer of the encoder to adjust the dimensions of the input embedding vector to a second dimension (e.g., a second dimension of size 128, etc.). In some examples, the linear layer of the encoder can adjust values associated with the tokens.

At block 606, the computing device (or component thereof) can adjust, using a layer (e.g., a convolution layer) of the encoder, an order of the modified plurality of tokens to generate a rearranged plurality of tokens. For example, the layer of the encoder is a convolution layer (e.g., a 1D convolution layer) that is part of a convolutional neural network (CNN). In some cases, the layer (e.g., the convolution layer) of the encoder can be used to mix an order of the modified plurality of tokens. In such an example, the modified plurality of tokens can be represented as a vector of tokens. The position of tokens within the vector can be rearranged using the layer (e.g., the convolution layer) of the encoder. In such an example, a token associated with a first position of the vector can be moved to another position of the vector (e.g., the 20 position, the 30th position, etc.).

At block 608, the computing device (or component thereof) can process the modified plurality of tokens and the rearranged plurality of tokens to determine relationships between input features of the plurality of tokens. For example, the computing device can determine relationships between input features of the plurality of tokens for object detection based on the plurality of tokens. In such an example, the plurality of tokens can be associated with 3D data of a 3D point cloud. The 3D point cloud can be associated with sensor data from a LIDAR sensor, RADAR sensor, or other ranging sensor. The computing device (or component thereof) can identify objects from the relationships of input features of the plurality of tokens.

FIG. 7 is a block diagram illustrating an example of a neural network (NN) 700 that can be used for 3D mesh reconstruction. The neural network 700 can include any type of deep network, such as a convolutional neural network (CNN), an autoencoder, a deep belief net (DBN), a Recurrent Neural Network (RNN), a Generative Adversarial Networks (GAN), an auto-regressive transformer models, and/or other type of neural network.

An input layer 710 of the neural network 700 includes input data. The input data of the input layer 710 can include image data, 3D point clouds, voxel values, token representations of voxels, depth data, pose data, weight volume values, or a combination thereof. In some examples, the input data of the input layer 710 can include the plurality of tokens generated by the 3D sparse backbone engine described further in the description of FIG. 3 and FIG. 4. In some examples, the input data of the input layer 710 includes processed data that is to be processed further, such as various features, weights, intermediate data, output(s) of certain intermediate layer(s) or node(s), or a combination thereof.

The neural network 700 includes multiple hidden layers 712A, 712B, through 712n. The hidden layers 712A, 712B, through 712n include “N” number of hidden layers, where “N” is an integer greater than or equal to one. The number of hidden layers can be made to include as many layers as needed for the given application. The neural network 700 further includes an output layer 714 that provides an output resulting from the processing performed by the hidden layers 712A, 712B, through 712n.

The neural network 700 is a multi-layer neural network of interconnected filters. Each filter can be trained to learn a feature representative of the input data. Information associated with the filters is shared among the different layers and each layer retains information as information is processed. In some cases, the neural network 700 can include a feed-forward network, in which case there are no feedback connections where outputs of the network are fed back into itself. In some cases, the network 700 can include a recurrent neural network, which can have loops that allow information to be carried across nodes while reading in input.

In some cases, information can be exchanged between the layers through node-to-node interconnections between the various layers. In some cases, the network can include a convolutional neural network, which may not link every node in one layer to every other node in the next layer. In networks where information is exchanged between layers, nodes of the input layer 710 can activate a set of nodes in the first hidden layer 712A. For example, as shown, each of the input nodes of the input layer 710 can be connected to each of the nodes of the first hidden layer 712A. The nodes of a hidden layer can transform the information of each input node by applying activation functions (e.g., filters) to this information. The information derived from the transformation can then be passed to and can activate the nodes of the next hidden layer 712B, which can perform their own designated functions. Example functions include convolutional functions, downscaling, upscaling, data transformation, and/or any other suitable functions. The output of the hidden layer 712B can then activate nodes of the next hidden layer, and so on. The output of the last hidden layer 712n can activate one or more nodes of the output layer 714, which provides a processed output image. In some cases, while nodes (e.g., node 716) in the neural network 700 are shown as having multiple output lines, a node has a single output and all lines shown as being output from a node represent the same output value.

In some cases, each node or interconnection between nodes can have a weight that is a set of parameters derived from the training of the neural network 700. For example, an interconnection between nodes can represent a piece of information learned about the interconnected nodes. The interconnection can have a tunable numeric weight that can be tuned (e.g., based on a training dataset), allowing the neural network 700 to be adaptive to inputs and able to learn as more and more data is processed.

In some aspects, training of one or more of the machine learning systems or neural networks described herein can be performed using online training (e.g., in some case on-device training), offline training, and/or various combinations of online and offline training. In some cases, online may refer to time periods during which the input data (e.g., such as the input data discussed with respect to the input layer 710) is processed, for instance for generating output data (e.g., such as the input data discussed with respect to the output layer 714). In some examples, offline may refer to idle time periods or time periods during which input data is not being processed. Additionally, offline may be based on one or more time conditions (e.g., after a particular amount of time has expired, such as a day, a week, a month, etc.) and/or may be based on various other conditions such as network and/or server availability, etc., among various others. In some aspects, offline training of a machine learning model (e.g., a neural network model) can be performed by a first device (e.g., a server device) to generate a pre-trained model, and a second device can receive the trained model from the second device. In some cases, the second device (e.g., a mobile device, an XR device, a vehicle or system/component of the vehicle, or other device) can perform online (or on-device) training of the pre-trained model to further adapt or tune the parameters of the model.

The neural network 700 is pre-trained to process the features from the data in the input layer 710 using the different hidden layers 712A, 712B, through 712n in order to provide the output through the output layer 714.

FIG. 8 is a diagram illustrating an example of a system for implementing certain aspects of the present technology. In particular, FIG. 8 illustrates an example of computing system 800, which can be for example any computing device making up internal computing system, a remote computing system, a LIDAR sensor, or any component thereof in which the components of the system are in communication with each other using connection 805. Connection 805 can be a physical connection using a bus, or a direct connection into processor 810, such as in a chipset architecture. Connection 805 can also be a virtual connection, networked connection, or logical connection.

In some aspects, computing system 800 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example computing system 800 includes at least one processor, such as a central processing unit (CPU), graphics processing unit (GPU), neural processing unit (NPU), digital signal processor (DSP), image signal processor (ISP), a field programmable gate array (FPGA), an application specific integrated circuit (ASIC), a microprocessor, a controller, another type of processing unit, another suitable electronic circuit, or a combination thereof. The computing system 800 also includes a connection 805 that couples various system components including system memory 815, such as read-only memory (ROM) 820 and random-access memory (RAM) 825 to processor 810. Computing system 800 can include a cache 812 of high-speed memory connected directly with, in close proximity to, or integrated as part of processor 810.

Processor 810 can include any general-purpose processor and a hardware service or software service, such as services 832, 834, and 836 stored in storage device 830, configured to control processor 810 as well as a special-purpose processor where software instructions are incorporated into the actual processor design. Processor 810 can essentially be a completely self-contained computing system, containing multiple cores or processors, a bus, memory controller, cache, etc. A multi-core processor can be symmetric or asymmetric.

To enable user interaction, computing system 800 includes an input device 845, which can represent any number of input mechanisms, such as a microphone for speech, a touch-sensitive screen for gesture or graphical input, keyboard, mouse, motion input, speech, etc. Computing system 800 can also include output device 835, which can be one or more of a number of output mechanisms. In some instances, multimodal systems can enable a user to provide multiple types of input/output to communicate with computing system 800. Computing system 800 can include communications interface 840, which can generally govern and manage the user input and system output. The communication interface can perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 840 can also include one or more Global Navigation Satellite System (GNSS) receivers or transceivers that are used to determine a location of the computing system 800 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here can easily be substituted for improved hardware or firmware arrangements as they are developed.

Storage device 830 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 830 can include software services, servers, services, etc. When the code that defines such software is executed by the processor 810, the code causes the system to perform a function. In some aspects, a hardware service that performs a particular function can include the software component stored in a computer-readable medium in connection with the necessary hardware components, such as processor 810, connection 805, output device 835, etc., to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium can include a non-transitory medium in which data can be stored and that does not include carrier waves and/or transitory electronic signals propagating wirelessly or over wired connections. Examples of a non-transitory medium can include, but are not limited to, a magnetic disk or tape, optical storage media such as compact disk (CD) or digital versatile disk (DVD), flash memory, memory or memory devices. A computer-readable medium can have stored thereon code and/or machine-executable instructions that can represent a procedure, a function, a subprogram, a program, a routine, a subroutine, a module, a software package, a class, or any combination of instructions, data structures, or program statements. A code segment can be coupled to another code segment or a hardware circuit by passing and/or receiving information, data, arguments, parameters, or memory contents. Information, arguments, parameters, data, etc. can be passed, forwarded, or transmitted using any suitable means including memory sharing, message passing, token passing, network transmission, or the like.

In some aspects, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects can be practiced without these specific details. For clarity of explanation, in some instances the present technology can be presented as including individual functional blocks including functional blocks comprising devices, device components, steps or routines in a method embodied in software, or combinations of hardware and software. Additional components can be used other than those shown in the figures and/or described herein. For example, circuits, systems, networks, processes, and other components can be shown as components in block diagram form in order not to obscure the aspects in unnecessary detail. In other instances, well-known circuits, processes, algorithms, structures, and techniques can be shown without unnecessary detail in order to avoid obscuring the aspects.

Individual aspects can be described above as a process or method which is depicted as a flowchart, a flow diagram, a data flow diagram, a structure diagram, or a block diagram. Although a flowchart can describe the operations as a sequential process, many of the operations can be performed in parallel or concurrently. In addition, the order of the operations can be re-arranged. A process is terminated when its operations are completed but could have additional steps not included in a figure. A process can correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions can be, for example, binaries, intermediate format instructions such as assembly language, firmware, source code, etc. Examples of computer-readable media that can be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) can be stored in a computer-readable or machine-readable medium. A processor(s) can perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts can be otherwise variously embodied and employed, and that the appended claims are intended to be construed to include such variations, except as limited by the prior art. Various features and aspects of the above-described application can be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods can be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” means A, B, or A and B. In another example, claim language reciting “at least one of A, B, and C” means A, B, C, or A and B, or A and C, or B and C, or A and B and C. The language “at least one of” a set and/or “one or more” of a set does not limit the set to the items listed in the set. For example, claim language reciting “at least one of A and B” can mean A, B, or A and B, and can additionally include items not listed in the set of A and B.

The various illustrative logical blocks, modules, circuits, and algorithm steps described in connection with the aspects disclosed herein can be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans can implement the described functionality in varying ways for each particular application, but such implementation decisions should not be interpreted as causing a departure from the scope of the present application.

The techniques described herein can also be implemented in electronic hardware, computer software, firmware, or any combination thereof. Such techniques can be implemented in any of a variety of devices such as general purposes computers, wireless communication device handsets, or integrated circuit devices having multiple uses including application in wireless communication device handsets and other devices. Any features described as modules or components can be implemented together in an integrated logic device or separately as discrete but interoperable logic devices. If implemented in software, the techniques can be realized at least in part by a computer-readable data storage medium comprising program code including instructions that, when executed, performs one or more of the methods described above. The computer-readable data storage medium can form part of a computer program product, which can include packaging materials. The computer-readable medium can comprise memory or data storage media, such as random-access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, can be realized at least in part by a computer-readable communication medium that carries or communicates program code in the form of instructions or data structures and that can be accessed, read, and/or executed by a computer, such as propagated signals or waves.

The program code can be executed by a processor, which can include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor can be configured to perform any of the techniques described in this disclosure. A general-purpose processor can be a microprocessor; but in the alternative, the processor can be any conventional processor, controller, microcontroller, or state machine. A processor can also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein can refer to any of the foregoing structure, any combination of the foregoing structure, or any other structure or apparatus suitable for implementation of the techniques described herein. In addition, in some aspects, the functionality described herein can be provided within dedicated software modules or hardware modules configured for encoding and decoding or incorporated in a combined video encoder-decoder (CODEC).

Claim language or other language reciting “at least one processor configured to,” “at least one processor being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor can only perform at least a subset of operations X, Y, and Z.

Illustrative aspects of the disclosure include:

Aspect 1: An apparatus for processing three-dimensional (3D) data, the apparatus comprising: one or more memories configured to store the 3D data; and one or more processors coupled to the one or more memories and configured to: process a plurality of voxels to generate a plurality of tokens associated with the 3D data; process, using a linear layer of an encoder, an embedding dimension of the plurality of tokens to modify the plurality of tokens; adjust, using a layer of the encoder, an order of the modified plurality of tokens to generate a rearranged plurality of tokens; and process the modified plurality of tokens and the rearranged plurality of tokens to determine relationships between input features of the plurality of tokens.

Aspect 2: The apparatus of Aspect 1, wherein the layer of the encoder is a convolution layer that is part of a convolutional neural network (CNN).

Aspect 3: The apparatus of any of Aspects 1 to 2, wherein the one or more processors are configured to process the embedding dimension and the rearranged plurality of tokens using element-wise multiplication of the embedding dimension and the rearranged plurality of tokens.

Aspect 4: The apparatus of any of Aspects 1 to 3, wherein the plurality of tokens is a plurality of one-dimensional (1D) sequential tokens.

Aspect 5: The apparatus of any of Aspects 1 to 4, wherein the rearranged plurality of tokens is the modified plurality of tokens arranged in raster order.

Aspect 6: The apparatus of any of Aspects 1 to 5, wherein the one or more processors are configured to adjust, using the layer of the encoder, the order of the modified plurality of tokens based on a local proximity relationship of tokens of the modified plurality of tokens.

Aspect 7: The apparatus of any of Aspects 1 to 6, wherein the one or more processors are configured to: detect an object based on the relationships between the input features of the embedding dimension and the plurality of tokens.

Aspect 8: The apparatus of any of Aspects 1 to 7, wherein the one or more processors are configured to: generate an aerial view representation of the plurality of voxels based on the relationships between the input features of the embedding dimension and the plurality of tokens.

Aspect 9: The apparatus of any of Aspects 1 to 8, wherein the one or more processors are configured to process the plurality of voxels to generate the plurality of tokens using partitions of a voxel from the plurality of voxels, wherein the plurality of tokens is associated with values associated with x-y coordinates of the partitions, and wherein tokens of the plurality of tokens are arranged in order based on the x-y coordinates.

Aspect 10: The apparatus of any of Aspects 1 to 9, further comprising a sensor configured to capture the 3D data.

Aspect 11: A method for processing three-dimensional (3D) data, the method comprising: processing a plurality of voxels to generate a plurality of tokens associated with the 3D data; processing, using a linear layer of an encoder, an embedding dimension of the plurality of tokens to modify the plurality of tokens; adjusting, using a layer of the encoder, an order of the modified plurality of tokens to generate a rearranged plurality of tokens; and processing the modified plurality of tokens and the rearranged plurality of tokens to determine relationships between input features of the plurality of tokens.

Aspect 12: The method of Aspect 11, wherein the layer of the encoder is a convolution layer that is part of a convolutional neural network (CNN).

Aspect 13: The method of any of Aspects 11 to 12, further comprising: processing the embedding dimension and the rearranged plurality of tokens using element-wise multiplication of the embedding dimension and the rearranged plurality of tokens.

Aspect 14: The method of any of Aspects 11 to 13, wherein the plurality of tokens is a plurality of one-dimensional (1D) sequential tokens.

Aspect 15: The method of any of Aspects 11 to 14, wherein the rearranged plurality of tokens is the modified plurality of tokens arranged in raster order.

Aspect 16: The method of any of Aspects 11 to 15, further comprising: adjusting, using the layer of the encoder, the order of the modified plurality of tokens based on a local proximity relationship of tokens of the modified plurality of tokens.

Aspect 17: The method of any of Aspects 11 to 16, detecting an object based on the relationships between the input features of the embedding dimension and the plurality of tokens.

Aspect 18: The method of any of Aspects 11 to 17, further comprising: generating an aerial view representation of the plurality of voxels based on the relationships between the input features of the embedding dimension and the plurality of tokens.

Aspect 19: The method of any of Aspects 11 to 18, further comprising: processing the plurality of voxels to generate the plurality of tokens using partitions of a voxel from the plurality of voxels, wherein the plurality of tokens is associated with values associated with x-y coordinates of the partitions, and wherein tokens of the plurality of tokens are arranged in order based on the x-y coordinates.

Aspect 20: An apparatus for processing three-dimensional (3D) data is provided. The apparatus includes one or more means for performing operations according to any of Aspects 11 to 19.

Aspect 21: A non-transitory computer-readable medium is provided having stored thereon instructions that, when executed by at least one processor, cause the at least one processor to perform operations according to any of Aspects 11 to 19.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but is to be accorded the full scope consistent with the language claims, wherein reference to an element in the singular is not intended to mean “one and only one” unless specifically so stated, but rather “one or more.”

What is claimed is:

1. An apparatus for processing three-dimensional (3D) data, the apparatus comprising:
one or more memories configured to store the 3D data; and
one or more processors coupled to the one or more memories and configured to:
process a plurality of voxels to generate a plurality of tokens associated with the 3D data;
process, using a linear layer of an encoder, an embedding dimension of the plurality of tokens to modify the plurality of tokens;
adjust, using a layer of the encoder, an order of the modified plurality of tokens to generate a rearranged plurality of tokens; and
process the modified plurality of tokens and the rearranged plurality of tokens to determine relationships between input features of the plurality of tokens.

2. The apparatus of claim 1, wherein the layer of the encoder is a convolution layer that is part of a convolutional neural network (CNN).

3. The apparatus of claim 1, wherein the one or more processors are configured to process the embedding dimension and the rearranged plurality of tokens using element-wise multiplication of the embedding dimension and the rearranged plurality of tokens.

4. The apparatus of claim 1, wherein the plurality of tokens is a plurality of one-dimensional (1D) sequential tokens.

5. The apparatus of claim 1, wherein the rearranged plurality of tokens is the modified plurality of tokens arranged in raster order.

6. The apparatus of claim 1, wherein the one or more processors are configured to adjust, using the layer of the encoder, the order of the modified plurality of tokens based on a local proximity relationship of tokens of the modified plurality of tokens.

7. The apparatus of claim 1, wherein the one or more processors are configured to:
detect an object based on the relationships between the input features of the embedding dimension and the plurality of tokens.

8. The apparatus of claim 1, wherein the one or more processors are configured to:
generate an aerial view representation of the plurality of voxels based on the relationships between the input features of the embedding dimension and the plurality of tokens.

9. The apparatus of claim 1, wherein the one or more processors are configured to process the plurality of voxels to generate the plurality of tokens using partitions of a voxel from the plurality of voxels, wherein the plurality of tokens is associated with values associated with x-y coordinates of the partitions, and wherein tokens of the plurality of tokens are arranged in order based on the x-y coordinates.

10. The apparatus of claim 1, further comprising a sensor configured to capture the 3D data.

11. A method for processing three-dimensional (3D) data, the method comprising:
processing a plurality of voxels to generate a plurality of tokens associated with the 3D data;
processing, using a linear layer of an encoder, an embedding dimension of the plurality of tokens to modify the plurality of tokens;
adjusting, using a layer of the encoder, an order of the modified plurality of tokens to generate a rearranged plurality of tokens; and
processing the modified plurality of tokens and the rearranged plurality of tokens to determine relationships between input features of the plurality of tokens.

12. The method of claim 11, wherein the layer of the encoder is a convolution layer that is part of a convolutional neural network (CNN).

13. The method of claim 11, further comprising:
processing the embedding dimension and the rearranged plurality of tokens using element-wise multiplication of the embedding dimension and the rearranged plurality of tokens.

14. The method of claim 11, wherein the plurality of tokens is a plurality of one-dimensional (1D) sequential tokens.

15. The method of claim 11, wherein the rearranged plurality of tokens is the modified plurality of tokens arranged in raster order.

16. The method of claim 11, further comprising:
adjusting, using the layer of the encoder, the order of the modified plurality of tokens based on a local proximity relationship of tokens of the modified plurality of tokens.

17. The method of claim 11, further comprising:
detecting an object based on the relationships between the input features of the embedding dimension and the plurality of tokens.

18. The method of claim 11, further comprising:
generating an aerial view representation of the plurality of voxels based on the relationships between the input features of the embedding dimension and the plurality of tokens.

19. The method of claim 11, further comprising:
processing the plurality of voxels to generate the plurality of tokens using partitions of a voxel from the plurality of voxels, wherein the plurality of tokens is associated with values associated with x-y coordinates of the partitions, and wherein tokens of the plurality of tokens are arranged in order based on the x-y coordinates.

20. A non-transitory computer-readable medium having stored thereon instructions that, when executed by at least one processor, cause the at least one processor to:
process a plurality of voxels to generate a plurality of tokens associated with 3D data;
process, using a linear layer of an encoder, an embedding dimension of the plurality of tokens to modify the plurality of tokens;
adjust, using a layer of the encoder, an order of the modified plurality of tokens to generate a rearranged plurality of tokens; and
process the modified plurality of tokens and the rearranged plurality of tokens to determine relationships between input features of the plurality of tokens.
